(19) United States
(12) Patent Application Publication
(10) Pub. No.: US 2005/0082267 A1
(43) Pub. Date: Apr. 21, 2005

(54) Laser beam machine

(76) Inventors: Yusuke Nagai, Tokyo (JP); Satoshi Kobayashi, Tokyo (JP); Yukio Morishige, Tokyo (JP); Masaru Nakamura, Tokyo (JP); Masahiro Murata, Tokyo (JP)

Correspondence Address: SMITH, GAMBRELL & RUSSELL, LLP, 1850 M STREET, N.W., SUITE 800, WASHINGTON, DC, 20036, US

(21) Appl. No.: 10/950,813

(22) Filed: Sep. 28, 2004

(30) Foreign Application Priority Data
Sep. 30, 2003 (JP) 2003-339297

(51) Int. Cl. B23K 26/00

(52) U.S. Cl. 219/121.82; 219/121.83

(57) ABSTRACT

A laser beam machine comprising a chuck table for holding a workpiece and a laser beam application means for applying a laser to the workpiece held on the chuck table, wherein the machine further comprises a processing sound wave detection means for detecting processing sound waves generated when a laser beam is applied to the workpiece from the laser beam application means and a control means for judging whether a detection signal from the processing sound wave detection means falls within a predetermined permissible range.

### FIELD OF THE INVENTION

The present invention relates to a laser beam machine for applying a laser to a workpiece to carry out predetermined processing.

### DESCRIPTION OF THE PRIOR ART

In the production process of a semiconductor device, a plurality of areas are sectioned by dividing lines called “streets” arranged in a lattice pattern on the front surface of a substantially disk-like semiconductor wafer and a circuit (device) such as IC, LSI or the like is formed in each of the sectioned areas. Individual semiconductor chips are manufactured by cutting this semiconductor wafer along the streets to divide it into the areas having the circuit thereon formed. An optical device wafer comprising gallium nitride-based compound semiconductors laminated on the front surface of a sapphire substrate is also cut along streets to be divided into individual optical devices such as light emitting diodes or laser diodes which are widely used in electric equipment.

Cutting along the streets of the above semiconductor wafer or optical device wafer is generally carried out by a cutting machine called “dicer”. This cutting machine comprises a chuck table for holding a workpiece such as a semiconductor wafer or optical device wafer, a cutting means for cutting the workpiece held on the chuck table, and a moving means for moving the chuck table and the cutting means relative to each other. The cutting means has a spindle unit which comprises a rotary spindle, a cutting blade mounted to the spindle and a drive mechanism for driving the rotary spindle. The cutting blade comprises a disk-like base and an annular edge which is mounted to the side wall outer peripheral portion of the base and formed as thick as about 20 μm by fixing diamond abrasive grains having a diameter of about 3 μm to the base by electroforming.

Since a sapphire substrate, silicon carbide substrate and the like have high Mohs hardness, cutting with the above cutting blade is not always easy. Since the cutting blade has a thickness of about 20 μm, the streets for sectioning devices needs to have a width of about 50 μm. Therefore, in the case of a device measuring about 300 μm×300 =m, the area ratio of the streets to the wafer is large, thereby reducing productivity.

Meanwhile, as a means of dividing a plate-like workpiece such as a semiconductor wafer, a laser beam processing method for applying a pulse laser beam capable of passing through the workpiece with its focusing point on the inside of the area to be divided is attempted and disclosed by JP-A 2002-192367, for example. In the dividing method using this laser beam processing technique, a workpiece is divided by applying a pulse laser beam having an infrared range, capable of passing through the work piece, from one side of the workpiece with its focusing point on the inside, to continuously form deteriorated layers along the streets in the inside of the workpiece and applying external force along the streets whose strength has been reduced by the formation of the deteriorated layers.

To divide the workpiece having deteriorated layers formed in the inside along the deteriorated layers without a failure, it is important that the deteriorated layers should be uniformly exposed to the top surface of the workpiece. Although the focusing point of the pulse laser beam is set to a position of a predetermined distance from the top surface of the workpiece so that the deteriorated layers are exposed to the top surface of the workpiece, the deteriorated layers may not be able to be uniformly exposed to the top surface of the workpiece when the top surface of the workpiece has undulation. In this case, a processing failure area that is difficult to be divided along the deteriorated layers is formed.

### SUMMARY OF THE INVENTION

It is an object of the present invention to provide a laser beam machine capable of detecting a processing failure area where a deteriorated layer formed in the inside of a workpiece by applying a laser beam to the workpiece is not exposed to the top surface of the workpiece.

To attain the above object, according to the present invention, there is provided a laser beam machine comprising a chuck table for holding a workpiece and a laser beam application means for applying a laser to the workpiece held on the chuck table, wherein
the machine further comprises a processing sound wave detection means for detecting processing sound waves generated when a laser beam is applied to the workpiece from the laser beam application means and a control means for judging whether a detection signal from the processing sound wave detection means falls within a predetermined permissible range.

The above control means comprises a storage means for storing the detection signal as one of failure site data when it is not fallen in the predetermined permissible range.

The above processing sound detection means is installed on the condenser of the laser beam application means. A plurality of the above processing sound wave detection means are installed on the chuck table.

A processing sound wave is detected and it is judged whether the processing sound wave falls within the predetermined permissible range to confirm a processing failure. Therefore, re-processing can be carried out according to circumstances, or the data can be effectively used for the analysis of a failure, etc.

### BRIEF DESCRIPTION OF THE DRAWINGS

FIG. 1 is a perspective view of a laser beam machine constituted according to the present invention;

FIG. 2 is a block diagram schematically showing the constitution of laser beam application means provided in the laser beam machine shown in FIG. 1;

FIG. 3 is a schematic diagram for explaining the focusing spot diameter of a pulse laser beam;

FIG. 4 is a perspective view of a semiconductor wafer as a workpiece;

FIGS. 5(a) and 5(b) are diagrams showing a state where a deteriorated layer is formed in the inside of a workpiece held on the chuck table of the laser beam machine shown in FIG. 1;

FIG. 6 is a diagram showing a state where a laminate of deteriorated layers are formed in the inside of the workpiece;

FIG. 7 is a diagram showing the output signals of processing sound wave detection means provided in the laser beam machine shown in FIG. 1;

FIG. 8 is a diagram showing data obtained by converting the output signals of the processing sound wave detection means shown in FIG. 7 into corresponding X-coordinate values; and

FIG. 9 is a front view of the processing sound wave detection means installed on the chuck table of the laser beam machine.

### DETAILED DESCRIPTION OF THE PREFERRED EMBODIMENTS

A laser beam machine according to preferred embodiments of the present invention will be described in detail hereinunder with reference to the accompanying drawings.

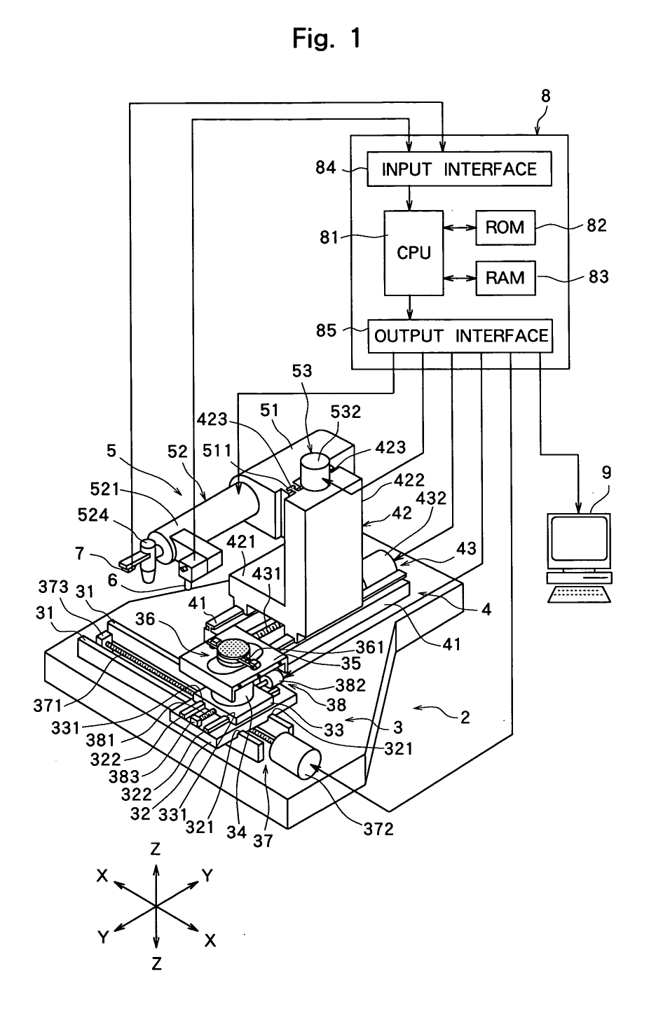

FIG. 1 is a perspective view of the laser beam machine constituted according to the present invention. The laser beam machine shown in FIG. 1 comprises a stationary base 2, a chuck table mechanism 3 for holding a workpiece, which is mounted on the stationary base 2 in such a manner that it can move in a processing-feed direction indicated by an arrow X, a laser beam application unit support mechanism 4 mounted on the stationary base 2 in such a manner that it can move in an indexing-feed direction indicated by an arrow Y perpendicular to the direction indicated by the arrow X, and a laser beam application unit 5 mounted on the laser beam application unit support mechanism 4 in such a manner that it can move in a direction indicated by an arrow Z.

The above chuck table mechanism 3 comprises a pair of guide rails 31 and 31 mounted on the stationary base 2 and arranged parallel to each other in the direction indicated by the arrow X, a first sliding block 32 mounted on the guide rails 31 and 3l in such a manner that it can move in the direction indicated by the arrow X, a second sliding block 33 mounted on the first sliding block 32 in such a manner that it can move in the direction indicated by the arrow Y, a support table 35 supported on the second sliding block 33 by a cylindrical member 34, and a chuck table 36 as a workpiece holding means. This chuck table 36 has an adsorption chuck 361 made of a porous material so that a disk-like semiconductor wafer as a workpiece is held on the adsorption chuck 361 by a suction means that is not shown. The chuck table 36 is rotated by a pulse motor (not shown) installed in the cylindrical member 34.

The above first sliding block 32 has, on its undersurface, a pair of to-be-guided grooves 321 and 321 to be fitted to the above pair of guide rails 31 and 31 and, on its top surface, a pair of guide rails 322 and 322 formed parallel to each other in the direction indicated by the arrow Y. The first sliding block 32 constituted as described above can move in the direction indicated by the arrow X along the pair of guide rails 31 and 31 by fitting the to-be-guided grooves 321 and 321 to the pair of guide rails 31 and 31, respectively. The chuck table mechanism 3 in the illustrated embodiment has a processing-feed means 37 for moving the first sliding block 32 along the pair of guide rails 31 and 31 in the processing-feed direction indicated by the arrow X. The processing-feed means 37 has a male screw rod 371 arranged between the above pair of guide rails 31 and 31 in parallel thereto and a drive source such as a pulse motor 372 for rotary-driving the male screw rod 371. The male screw rod 371 is, at its one end, rotatably supported to a bearing block 373 fixed on the above stationary base 2 and is, at its other end, connected to the output shaft of the above pulse motor 372 by a speed reducer that is not shown. The male screw rod 371 is screwed into a threaded through-hole formed in a female screw block (not shown) projecting from the undersurface of the center portion of the first sliding block 32. Therefore, by driving the male screw rod 371 in a normal direction or reverse direction with the pulse motor 372, the first sliding block 32 is moved along the guide rails 31 and 31 in the processing-direction indicated by the arrow X.

The above second sliding block 33 has, on the undersurface, a pair of to-be-guided grooves 331 and 331 to be fitted to the pair of guide rails 322 and 322 on the top surface of the above first sliding block 32 and can move in the indexing-feed direction indicated by the arrow Y by fitting the to-be-guided grooves 331 and 331 to the pair of guide rails 322 and 322, respectively. The chuck table mechanism 3 in the illustrated embodiment comprises a first indexing-feed means 38 for moving the second sliding block 33 in the indexing-feed direction indicated by the arrow Y along the pair of guide rails 322 and 322 on the first sliding block 32. The first indexing-feed means 38 has a male screw rod 381 which is arranged between the above pair of guide rails 322 and 322 in parallel thereto, and a drive source such as a pulse motor 382 for rotary-driving the male screw rod 381. The male screw rod 381 is, at its one end, rotatably supported to a bearing block 383 fixed on the top surface of the above first sliding block 32 and is, at its other end, connected to the output shaft of the above pulse motor 382 by a speed reducer that is not shown. The male screw rod 381 is screwed into a threaded through-hole formed in a female screw block (not shown) projecting from the undersurface of the center portion of the second sliding block 33. Therefore, by driving the male screw rod 381 in a normal direction or reverse direction with the pulse motor 382, the second sliding block 33 is moved along the guide rails 322 and 322 in the indexing-feed direction indicated by the arrow Y.

The above laser beam application unit support mechanism 4 comprises a pair of guide rails 41 and 41 mounted on the stationary base 2 and arranged parallel to each other in the indexing-feed direction indicated by the arrow Y and a movable support base 42 mounted on the guide rails 41 and 41 in such a manner that it can move in the indexing-feed direction indicated by the arrow Y. This movable support base 42 comprises a movable support portion 421 movably mounted on the guide rails 41 and 41 and a mounting portion 422 mounted on the movable support portion 421. The mounting portion 422 is provided with a pair of guide rails 423 and 423 extending in the direction indicated by the arrow Z. The laser beam application unit support mechanism 4 in the illustrated embodiment has a second indexing-feed means 43 for moving the movable support base 42 along the pair of guide rails 41 and 41 in the indexing-feed direction indicated by the arrow Y. This second indexing-feed means 43 has a male screw rod 431 arranged between the above pair of guide rails 41 and 41 in parallel thereto, and a drive source such as a pulse motor 432 for rotary-driving the male screw rod 431. The male screw rod 431 is, at its one end, rotatably supported to a bearing block (not shown) fixed on the above stationary base 2 and is, at its other end, connected to the output shaft of the above pulse motor 432 by a speed reducer that is not shown. The male screw rod 431 is screwed into a threaded through-hole formed in a female screw block (not shown) projecting from the undersurface of the center portion of the movable support portion 421 constituting the movable support base 42. Therefore, by driving the male screw rod 431 in a normal direction or reverse direction with the pulse motor 432, the movable support base 42 is moved along the guide rails 41 and 41 in the indexing-feed direction indicated by the arrow Y.

The laser beam application unit 5 in the illustrated embodiment comprises a unit holder 51 and a laser beam application means 52 secured to the unit holder 51. The unit holder 51 has a pair of to-be-guided grooves 511 and 511 to be slidably fitted to the pair of guide rails 423 and 423 on the above mounting portion 422 and is supported in such a manner that it can move in the direction indicated by the arrow Z by fitting the to-be-guided grooves 511 and 511 to the above guide rails 423 and 423, respectively.

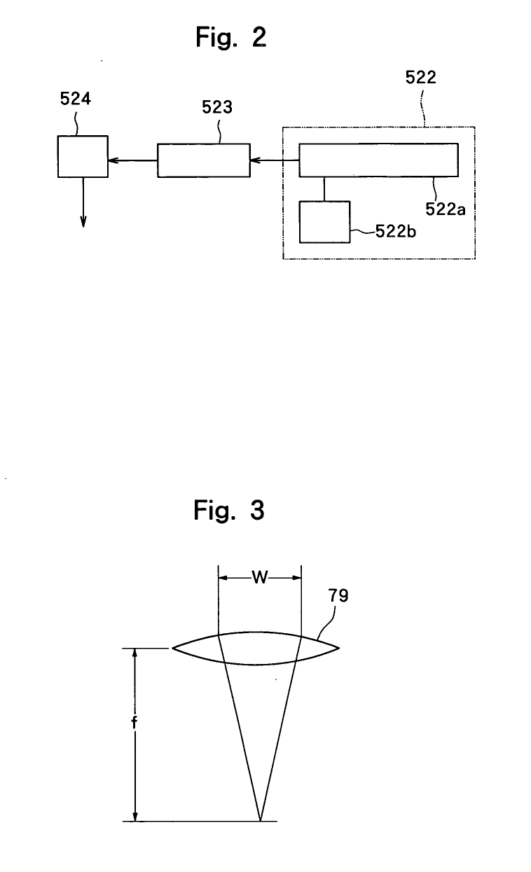

The illustrated laser beam application means 52 comprises a cylindrical casing 521 secured to the above unit holder 51 and extending substantially horizontally. In the casing 521, there are installed a pulse laser beam oscillation means 522 and a transmission optical system 523, as shown in FIG. 2. The pulse laser beam oscillation means 522 is constituted by a pulse laser beam oscillator 522a composed of a YAG laser oscillator or YVO4 laser oscillator and a repetition frequency setting means 522b connected to the pulse laser beam oscillator 522a. The transmission optical system 523 has suitable optical elements such as abeam splitter, etc. A condenser 524 housing condensing lenses (not shown) constituted by a set of lenses that may be a formation known per se is attached to the end of the above casing 521.

A laser beam oscillated from the above pulse laser beam oscillation means 522 reaches the condenser 524 through the transmission optical system 523 and is applied from the condenser 524 to the workpiece held on the above chuck table 36 at a predetermined focusing spot diameter D. This focusing spot diameter D is defined by the expression D (μm)=4×λ×f/(π×W) (wherein λ is the wavelength (μm) of the pulse laser beam, W is the diameter (mm) of a pulse laser beam applied to the objective lens 524a, and f is the focusing distance (mm) of the objective lens 524a) when the pulse laser beam having a Gauss distribution is applied through the objective lens 524a of the condenser 524 as shown in FIG. 3.

Returning to FIG. 1, an image pick-up means 6 is situated at the front end of the casing 521 constituting the above laser beam application means 52. This image pick-up means 6 in the illustrated embodiment is constituted by an infrared illuminating means for applying infrared radiation to the workpiece, an optical system for capturing infrared radiation applied by the infrared illuminating means, and an image pick-up device (infrared CCD) for outputting an electric signal corresponding to infrared radiation captured by the optical system, in addition to an ordinary image pick-up device (CCD) for picking up an image with visible radiation. Animate signal is transmitted to a control means later described.

The laser beam application unit 5 in the illustrated embodiment comprises a focusing point position adjusting means 53 for moving the unit holder 51 along the pair of guide rails 423 and 423 in the direction indicated by the arrow Z. The focusing point position adjusting means 53 has a male screw rod (not shown) arranged between the pair of guide rails 423 and 423 and a drive source such as a pulse motor 532 for rotary-driving the male screw rod. By driving the male screw rod (not shown) in a normal direction or reverse direction with the pulse motor 532, the unit holder 51 and the laser beam application means 52 are moved along the guide rails 423 and 423 in the direction indicated by the arrow Z. In the illustrated embodiment, the laser beam application means 52 is so constituted as to move up by driving the pulse motor 532 in a normal direction and as to move down by driving the pulse motor 532 in the reverse direction. Therefore, the focusing point position adjusting means 53 can adjust the position of the focusing point of the laser beam applied by the condenser 524 attached to the end of the casing 521.

The laser beam machine in the illustrated embodiment comprises a processing sound wave detection means 7 for detecting a processing sound wave generated at the time when a laser beam from the above laser beam application means 52 is applied the workpiece held on the chuck table 36. This processing sound wave detection means 7 is composed of an ultrasonic detector in the illustrated embodiment and fitted to the above condenser 524. The processing sound wave detection means 7 that is composed of the ultrasonic detector transmits its detection signal to the control means 8 as a voltage signal. The control means 8 is composed of a computer which comprises a central processing unit (CPU) 81 for carrying out arithmetic processing based on a control program, a read-only memory (ROM) 82 for storing the control program, etc., a read/write random access memory (RAM) 83 for storing the results of operations, an input interface 84 and an output interface 85. Detection signals from the processing sound detection means 7 and the image pick-up means 6 are input to the input interface 84 of the control means 8 thus constituted. Control signals are output from the output interface 85 to the above pulse motor 372, pulse motor 382, pulse motor 432, pulse motor 532, laser beam application means 52, display means 9 and the like.

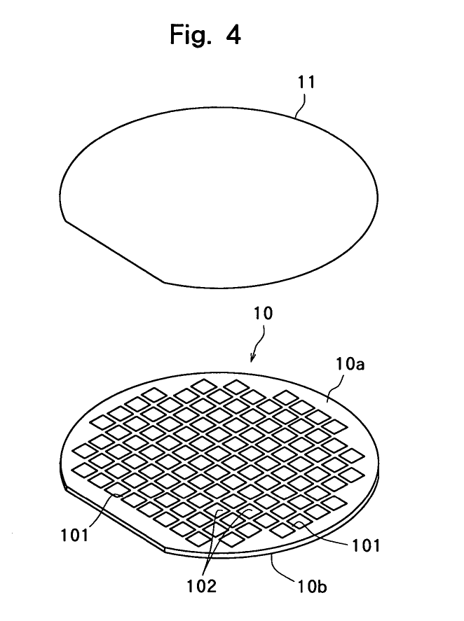

The laser beam machine in the illustrated embodiment is constituted as described above, and its operation of processing the semiconductor wafer 10 shown in FIG. 4 will be described hereinbelow.

In the semiconductor wafer 10 shown in FIG. 4, a plurality of areas are sectioned by a plurality of streets 101 formed in a lattice pattern on the front surface 10a of a semiconductor wafer such as a silicon wafer, and a circuit 102 such as IC, LSI or the like is formed in each of the sectioned areas. The semiconductor wafer 10 constituted as described above has a protective tape 11 affixed to the front surface 10a and is suction-held on the chuck table 36 in such a manner that the back surface 10b faces up. The chuck table 36 suction-holding the semiconductor wafer 10 is moved along the guide rails 31 and 31 by the operation of the processing-feed means 37 to be brought to a position right below the image pick-up means 6 mounted on the laser beam application unit 5.

After the chuck table 36 is positioned right below the image pick-up means 6, alignment work for detecting a processing area to be processed by a laser beam of the semiconductor wafer 10 is carried out by the image pick-up means 6 and the control means 8. That is, the image pick-up means 6 and the control means 8 carry out image processing such as pattern matching to align a street 101 formed in a predetermined direction of the semiconductor wafer 10 with the condenser 524 of the laser beam application unit 5 for applying a laser beam along the street 101, there by performing the alignment of a laser beam application position. The alignment of the laser beam application position is also carried out on streets 101 extending in a direction perpendicular to the above predetermined direction formed on the semiconductor wafer 10. At this point, although the front surface 10a, on which the streets 101 are formed, of the semiconductor wafer 10 faces down, the street 101 can be imaged from the back surface 10b as the image pick-up means 6 comprises an infrared illuminating means, an optical system for capturing infrared radiation and an image pick-up device (infrared CCD) for outputting an electric signal corresponding to the infrared radiation as described above.

After the street 101 formed on the semiconductor wafer 10 held on the chuck table 36 is detected and the alignment of the laser beam application position is carried out as described above, the chuck table 36 is moved to a laser beam application range where the condenser 524 of the laser beam application means 52 for applying a laser beam is located to bring one end (left end in FIG. 5(a)) of the predetermined street 101 to a position right below the condenser 524 of the laser beam application means 52 as shown in FIG. 5(a). The chuck table 36, that is, the semiconductor wafer 10, is moved in the direction indicated by the arrow X1 in FIG. 5(a) at a predetermined feed rate while a pulse laser beam capable of passing through the semiconductor wafer 10 is applied from the condenser 524. When the application position of the condenser 524 of the laser beam application means 52 reaches the other end (right end in FIG. 5(b)) of the street 101 as shown in FIG. 5(b), the application of the pulse laser beam is suspended and the movement of the chuck table 36, that is, the semiconductor wafer 10, is stopped. In this laser beam application step, when the focusing point P of the pulse laser beam is set near the front surface 10a (undersurface) of the wafer 10, a deteriorated layer 110 can be formed toward the inside from the front surface 10a (undersurface).

The processing conditions in the above laser beam application step are set as follows, for example.
Light source: Nd:YVO4 pulse laser
Wavelength: 1,064 nm
Pulse energy: 10 to 40 μm
Repetition frequency: 100 kHz
Pulse width: 40 to 100 ns
Focusing spot diameter: 1 μm
Processing feed rate: 100 mm/sec

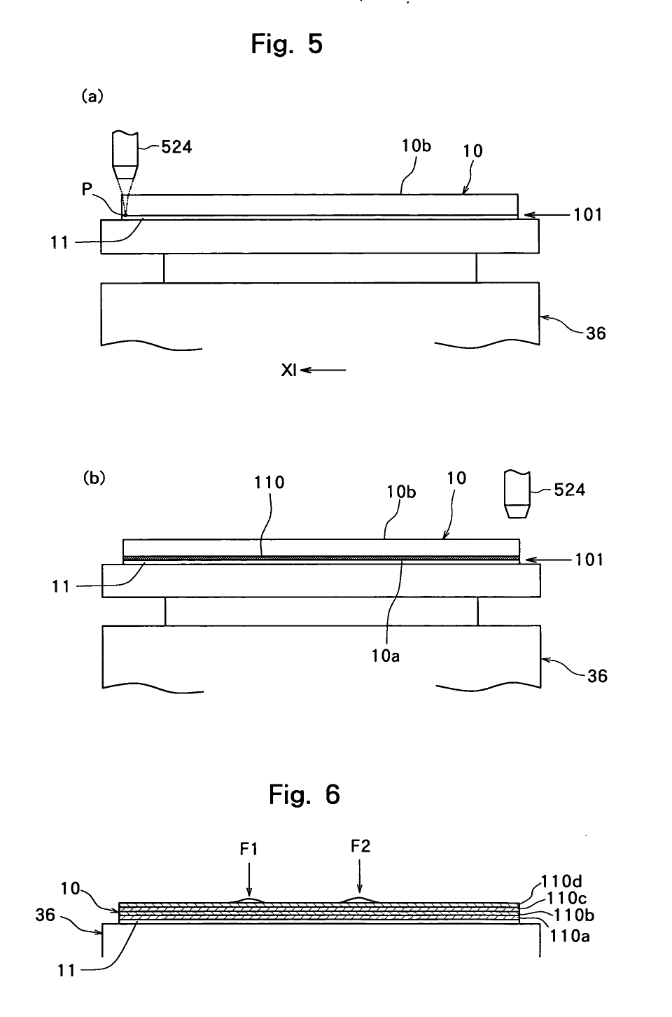

When the semiconductor wafer 10 is thick, the above laser beam application step is carried out several times by changing the focusing point P stepwise to form a plurality of deteriorated layers 110a, 10b, 110c and 110d as shown in FIG. 6. In the illustrated embodiment, the uppermost deteriorated layer 110d is so set as to be exposed to the back surface 10b (top surface) of the semiconductor wafer 10. However, when the semiconductor wafer 10 changes in thickness due to undulation of the back surface 10b (top surface), areas F1 and F2 where the uppermost deteriorated layer 110d is not exposed to the back surface 10b (top surface) of the semiconductor wafer 10 are produced, as shown in FIG. 6. When there exist such areas where the deteriorated layer is not exposed to the top surface, it becomes difficult to divide the semiconductor wafer 10 along the deteriorated layers.

The laser beam machine in the illustrated embodiment detects the existence of the areas F1 and F2 where the above deteriorated layer is not exposed to the top surface as follows.

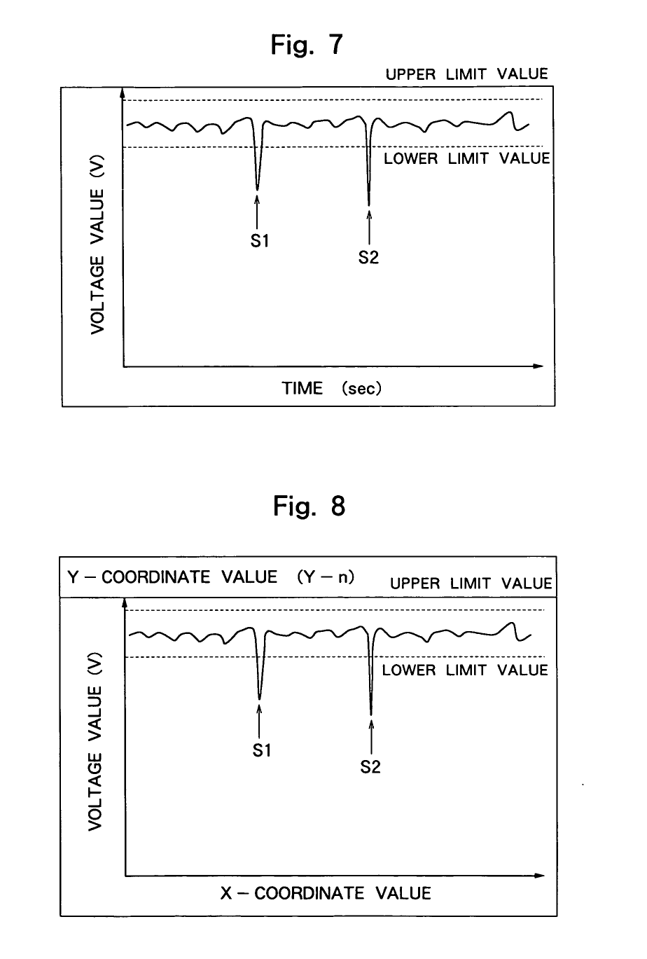

That is, in the laser beam machine in the illustrated embodiment, ultrasonic waves propagated to a gas phase out of ultrasonic waves generated when a laser beam is applied to the workpiece held on the chuck table are detected by the processing sound wave detection means 7 that is composed of an ultrasonic detector installed on the above condenser 524. This processing sound wave detection means 7 outputs the detected ultrasonic waves as voltage signals as shown in FIG. 7. In FIG. 7, time (seconds) is plotted on the horizontal axis and the voltage value (V) output from the processing sound wave detection means 7 is plotted on the vertical axis. In FIG. 7, the voltage value produced when the deteriorated layer is exposed to the top surface of the semiconductor wafer 10 is in the range of 5 to 6 V (permissible range). On the other hand, when the deteriorated layer is not exposed to the top surface of the semiconductor wafer 10, the voltage value output from the processing sound wave detection means 7 drops. That is, as shown by S1 and S2 in FIG. 7, the output voltages from the processing sound wave detection means 7 drop in the areas shown by F1 and F2 in FIG. 6.

As described above, the processing sound wave detected by the processing sound wave detection means 7 is transmitted to the control means 8 as a voltage signal. The control means 8 converts the data of FIG. 7 on the horizontal axis into the X-coordinate values as shown in FIG. 8. The X-coordinate values can be obtained based on the number of pulses to be applied to the pulse motor 372 of the processing-feed means 37 when the chuck table 36 is moved in the processing-feed direction from a predetermined standard position. The Y-coordinate values of detection data shown in FIG. 8 can be obtained based on the number of pulses to be applied to the pulse motor 382 of the first indexing-feed means 38 or the pulse motor 432 of the second indexing-feed means 43 when the chuck table 36 is moved in the indexing-feed direction from a predetermined standard position. Therefore, the detection data shown in FIG. 8 are X-coordinate data at predetermined Y-coordinate values (Y-n). After the data detected by the processing sound wave detection means 7 are thus converted into X and Y coordinate data shown in FIG. 8, the control means 8 temporarily stores the data in the random access memory (RAM) 83. The above work is carried out on all the streets 101 formed on the semiconductor wafer 10, and the obtained data are temporarily stored in the random access memory (RAM) 83. The control means 8 judges whether there exist or not data having voltage data lower (or higher) than the above permissible range in the resulting data, and when such abnormal data exist, the control means 8 further judges that an area where the deteriorated layer is not exposed to the top surface of the semiconductor wafer 10 is produced. Then, the data thus judged are stored as failure site data in the storage domain of the random access memory (RAM) 83 as the storage means. Then, the control means 8 displays this failure site data on the display means 9 as required. In the laser beam machine in the illustrated embodiment, as the failure site of the semiconductor wafer 10 that has been processed by a laser beam can be confirmed from the above failure site data, re-processing maybe carried out according to circumstances, or the data can be effectively used for the analysis of a failure.

In the above embodiment, only one processing sound wave detection means 7 is provided. By providing a plurality of special processing soundwave detection means 7 corresponding to the repetition frequencies of a laser beam, receiver sensitivity can be increased and a very small change in the deteriorated layer can be detected even when the repetition frequency of the laser beam is changed for processing.

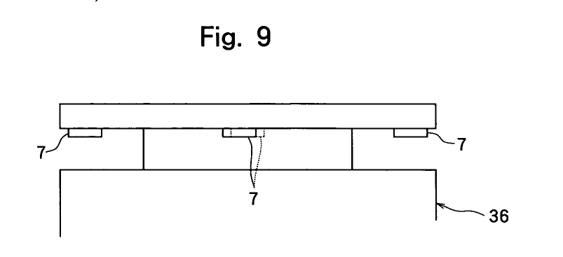

Another embodiment of the present invention will be described with reference to FIG. 9.

In the embodiment shown in FIG. 9, a plurality of (4 in the illustrated embodiment) processing sound wave detection means 7, each composed of an ultrasonic detector, are installed on the chuck table 36. By installing a plurality of processing sound wave detection means 7 on the chuck table 36, the control means 8 can select a sound signal from the plurality of processing soundwave detection means 7 according to the processing position of the workpiece held on the chuck table. When processing sound wave detection means 7 are installed on the chuck table 36 side, the attenuation of a sound wave in the workpiece is small and the workpiece can be arranged in contact with the processing sound wave detection means 7, thereby making it possible to suppress reflection caused by the mismatch of acoustic impedance between the workpiece and the processing sound wave detection means 7. Therefore, a soundwave generated by processing can be received with high accuracy having little noise. As a result, it is possible to detect not only the exposition of the deteriorated layer to the top surface of the workpiece but also a very small change in the deteriorated layer formed in the workpiece.

1. A laser beam machine comprising a chuck table for holding a workpiece and a laser beam application means for applying a laser to the workpiece held on the chuck table, wherein
the machine further comprises a processing sound wave detection means for detecting processing sound waves generated when a laser beam is applied to the workpiece from the laser beam application means and a control means for judging whether a detection signal from the processing sound wave detection means falls within a predetermined permissible range.

2. The laser beam machine according to claim 1, wherein the control means comprises a storage means for storing the detection signal as one of failure site data when it is not fallen in the predetermined permissible range.

3. The laser beam machine according to claim 1, wherein the processing sound wave detection means is installed on the condenser of the laser beam application means.

4. The laser beam machine according to claim 1, wherein a plurality of the processing sound wave detection means are installed on the chuck table.
